(19) United States
(12) Patent Application Publication
(10) Pub. No.: US 2013/0082070 A1
(43) Pub. Date: Apr. 4, 2013

(54) FLUID DISPENSING DEVICE

(71) Applicant: EP SYSTEMS SA, Neuchatel (CH)

(72) Inventors: Amir Feriani, Auvernier (CH); Patrick Muller, Saint-Aubin sur Gaillon (FR)

(73) Assignee: EP SYSTEMS SA, Neuchatel (CH)

(21) Appl. No.: 13/623,312

(22) Filed: Sep. 20, 2012

(30) Foreign Application Priority Data
Sep. 20, 2011 (EP) 11 182 028.8

(51) Int. Cl. F21V 33/00

(52) U.S. Cl. CPC F21V 33/0004
USPC 222/113

(57) ABSTRACT

The present invention relates to a fluid dispensing device (1) comprising a container (2) suitable for holding the fluid, such as a perfume, a decorative body (5) located inside the container (2) and destined to be located in the fluid, wherein the decorative body (5) includes light emitting means (13), and activation means (14) for activating the light emitting means (13). The fluid dispensing device further includes a passive label (23) arranged externally to the container (2) and adapted to cooperate with an LCR circuit (22) to control activation of the light emitting means (13).

This application claims priority from European Patent Application No. 11 182 028.8, filed Sep. 20, 2011, the entire disclosure of which is incorporated herein by reference.

### FIELD OF THE INVENTION

The present invention concerns a fluid dispensing device such as a perfume dispenser comprising a container suitable for holding fluid as well as a decorative body located inside the container and destined to be located inside the fluid of the container.

### BACKGROUND OF THE INVENTION

A known fluid dispensing device has a decorative body inside its container containing perfume. The decorative body may be fixed on the internal tube or is a passive pearl-like body. In order to bring out the presence of the pearl-like body, it is necessary to illuminate the body or a tube in the bottle that transports fluid out of the bottle. See for example, the document U.S. Pat. No. 7,258,458, the document U.S. Pat. No. 6,588,435 or also the document US 20070007304.

Other devices are known, see, for example, the document US 20010032655, which describes a container having a cap. The cap has a recess in which an entertainment device is disposed. The entertainment device may include a touch-activated light and/or sound package. When the user depresses an element on the cap, a touch switch is activated, and the light package lights up and/or the sound package generates a sound or noise. Alternatively, the cap may include one or more fluids disposed in the cap; the fluids are preferably immiscible.

Inside the bottle and in the fluid of the fluid dispensing device, the light illuminating the decorative body provides an aesthetically pleasing effect, for example, similar to that of a swimming pool or fountain that is illuminated via underwater lighting.

However, such illumination requires external illumination means having circuitry, such as a power source, electrodes and an electronic control circuit. Such external circuitry has problems due to the risk of contacts or other components of the circuitry being damaged resulting in a malfunctioning of the illumination means.

### SUMMARY OF THE INVENTION

The present invention allows this problem to be overcome through the decorative body of the fluid dispensing device including internal circuitry to illuminate the decorative body. Furthermore, the internal circuitry comprises motion detection means for detecting movement of the fluid dispensing device. A passive label may further be provided.

This fluid dispensing device permits the aesthetically pleasing effect to be activated in a simply manner when the fluid dispensing device is being used by the perfume user without any cumbersome connection of external means.

Other details and different variants of the invention are defined in the additional embodiments.

Another aspect of the invention relates to a packaging comprising a fluid dispensing device and the passive label.

Thus, in accordance with a first non-limiting illustrative embodiment of the invention, a fluid dispensing device (1) is provided that includes: (a) a container (2) suitable for holding the fluid, wherein the container (2) is a sealed liquid-tight container; (b) a decorative body (5) located inside the container (2) and destined to be located in the fluid, wherein the decorative body (5) includes light emitting means (13), and activation means (14) for activating the light emitting means (13), wherein the activation means (14) includes a motion detector (14A) for detecting movement of the fluid dispensing device (1), wherein the decorative body (5) further comprises energy saving means (21) for preventing operation of the activation means (14), wherein the energy saving means (21) includes a LCR circuit (22); (c) a passive label (23) arranged externally to the container (2) and adapted to cooperate with the LCR circuit (22) to control activation of the light emitting means (13), wherein the passive label is an iron ribbon or an RF tag and the LCR circuit (22) is adapted to detect the presence of the passive label (23). In accordance with a second non-limiting illustrative embodiment of the present invention, the first illustrative embodiment is modified so that the motion detector (14A) comprises a mass (15A), a spring (16) and an annular contact (17) surrounding the mass (15A) and spring (16).

In accordance with a third non-limiting illustrative embodiment of the present invention, the first and second illustrative embodiments are further modified so that the activation means (14) further comprises a controller (19) for controlling activation of the light emitting means (13). In accordance with a fourth non-limiting, illustrative embodiment of the present invention, the first, the second, and the third illustrative embodiments are further modified so that the light emitting means (13) comprises a white light emitting diode. In accordance with a fifth non-limiting illustrative embodiment of the present invention, the first, second, third and fourth illustrative embodiments are further modified so that the fluid dispensing device (1) further comprises a spray cap (5a) and a protective cap (4a) arranged to cover the spray cap (5A) in order to avoid unintentional activation of the fluid dispenser. In accordance with a sixth non-limiting illustrative embodiment of the present invention, the fifth illustrative embodiment is modified so that the fluid dispensing device (1) further comprises the passive label (23) fixed to the protective cap (4a) and adapted to cooperate with the LCR circuit (22).

In accordance with a seventh non-limiting illustrative embodiment of the present invention, the first, second, third, fourth, fifth and sixth illustrative embodiments are further modified so that the decorative body (5) is translucent. In accordance with an eighth non-limiting illustrative embodiment of the present invention, the first, second, third, fourth, fifth, sixth, and seventh illustrative embodiments are further modified so that the fluid is perfume.

### BRIEF DESCRIPTION OF THE DRAWINGS

The invention will be better understood with the help of the following detailed description and the accompanying drawings illustrating possible embodiments of the invention:

FIG. 1 is a schematic front view of a fluid dispensing device according to the present invention;

FIG. 2 is a schematic illustration of a decorative body of a first embodiment of the present invention that is destined to be located inside a container of the fluid dispensing device of the present invention;

FIG. 3 is a schematic illustration of a second embodiment of the present invention wherein a decorative body, similar to that illustrated of FIG. 2, further includes a controller for controlling activation of a light emission means' and

FIG. 4 is a schematic illustration of a third embodiment of the present invention where the decorative body of FIG. 3 further includes energy saving means for preventing operation of the controller for controlling activation of the light emitting means.

### DETAILED DESCRIPTION OF THE INVENTION

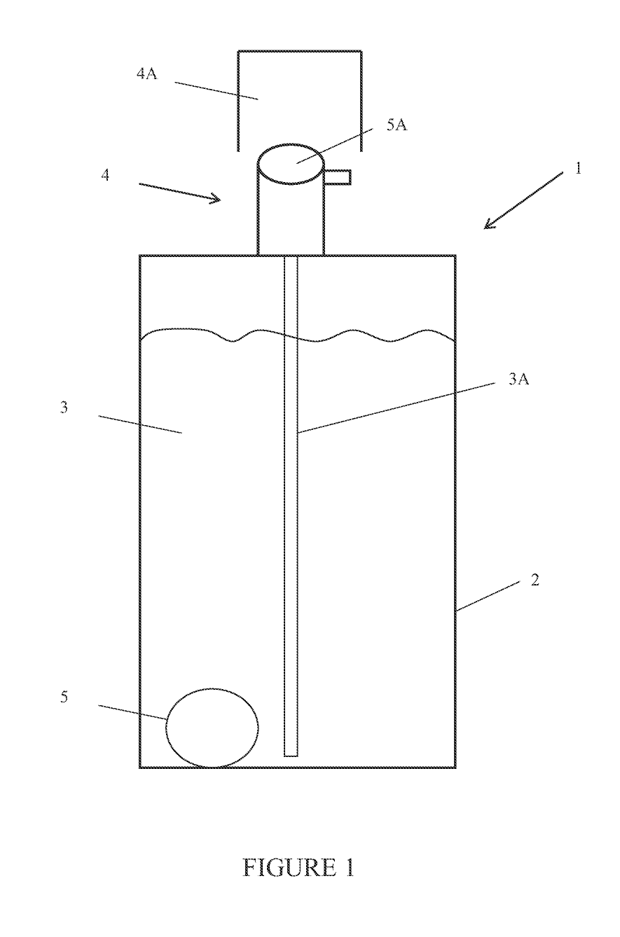

FIG. 1 shows a fluid dispensing device 1 according to the present invention. The fluid dispensing device comprises a container 2 suitable for holding a fluid 3 such as, for example, a cosmetic liquid such as a perfume. The container 2 can be made of glass or plastic, for example.

The fluid dispensing device further includes a distribution pump 4 and a decorative body 5. The distribution pump 4 is fixed to the container 2 and includes a spray cap 5A that can be actioned to vaporise and distribute the fluid 3. The container 2 is sealed by the distribution pump 4. A protective cap 4A may be provided to cover spray cap 5A in order to avoid unintentional activation of the fluid dispenser.

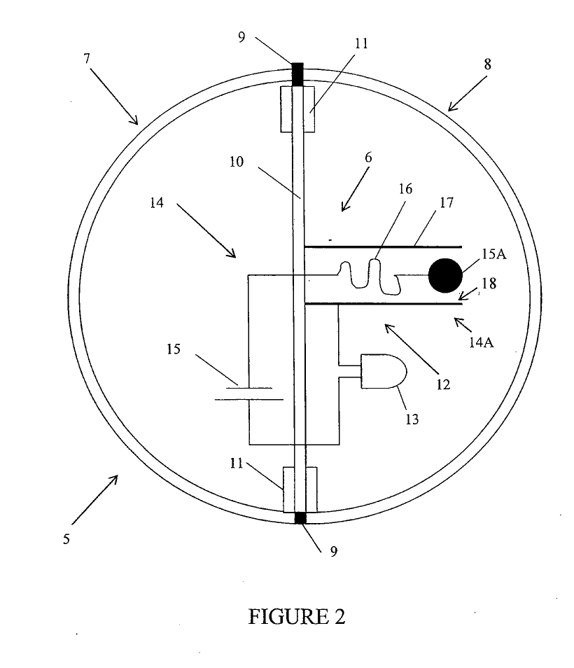

The decorative body 5 is located inside the container 2 and in the fluid 3. The decorative body 5 is made of a translucent or transparent material, for example, of glass or plastic, and is liquid proof meaning that the fluid 3 cannot penetrate into the interior of the decorative body 5. The decorative body 5 comprises an inner chamber that defines a space in which an electronic circuit 6 is placed (FIG. 2).

As illustrated in FIG. 2, in a first exemplary embodiment of the present invention, the decorative body 5 comprises a first portion 7 and a second portion 8 that are fixed together, for example, using an ultrasonic welding or adhesive or cement, preferably, of a colour similar to that of an exterior surface of the decorative body 5.

The first portion 7 and the second portion 8 are each of a substantially half shape such that decorative body 5 has a substantially complete shape, for example, the first portion 7 and the second portion 8 are each of a substantially half-spherical shape such that decorative body 5 has a substantially spherical shape when the first portion 7 and the second portion 8 are fixed together. The diameter of the decorative body may be, for example, about 15 mm.

While ultrasonic welding or adhesive or cement can be used to render the decorative body 5 liquid proof, a seal 9 can optionally be additionally placed on the circumferential interface between the first portion 7 and the second portion 8. The seal 9 can be, for example, a rubber stripe or strip, preferably of a colour similar to that of the exterior surface of the decorative body 5.

The electronic circuit 6 includes a support 10 and components 12. The support 10 is a circuit board whose length is substantially equal to that of the inner diameter of the decorative body 5 to immobilise the electronic circuit 6 inside the decorative body 5.

Optionally, the electronic circuit 6 may further include stop portions 11. Each stop portion 11 is made of rubber and is U-shaped, that is, the stop portion 11 comprises two elongated legs interconnected via a base portion. The U-shaped stop portion 11 is placed on the outer extremities of support 10. The outer extremities of support 10 are surrounded by the elongated legs and abut the base portion of the stop portion 11. Stop portion 11 further ensures that the electronic circuit 6 is immobilised inside the decorative body 5. In a second option, the components 12 may further be integrated and fixed directly to the inner periphery of the decorative body 5.

The components 12 of the electronic circuit 6 include a light emitting means 13 and activation means 14 for activating the light emitting means 13. The light emitting means 13 may be a light emitting diode.

The activation means 14 of the present embodiment, illustrated in FIG. 2, includes a motion detector 14A and a battery 15 for providing current to the light emitting means 13. The battery 15 is placed inside the decorative body 5 and has enough energy for a normal use of the fluidic dispensing device liquid volume. For example, the liquid volume of the fluidic dispensing device may be 100 ml.

The motion detector 14A is a mechanical motion detector comprising a metallic mass 15A, a spring 16 and a metallic annular contact 17. The mass 15A is mounted to one end of the spring 16 and the other end of the spring 16 is fixed to the support 10.

The spring 16 and the mass 15A extend from the surface of support 10, in a direction substantially perpendicular to the surface of support 10. The annular contact 17 is fixed at one end to the surface of support 10 and extends from this surface, in a direction substantially perpendicular to the surface and encloses the spring 16 and the mass 15A.

The annular contact 17 includes an annular contact surface 18 on its inner surface facing the spring 16 and the mass 15A. When the fluidic dispensing device 1 or the decorative body is moved, the mass 15A is set into oscillation via the action of the spring 16 and comes into contact with the annular contact surface 18.

In the present embodiment, one terminal of the battery 15 is connected to one terminal of the light emitting means 13 and the other terminal of the battery 15 is connected to the extremity of the spring 16 fixed to the support 10. The remaining terminal of the light emitting means 13 is connected to the annular contact 17.

When the fluid dispensing device 1 and/or the decorative body 5 is moved, the mass 15A comes into contact with annular contact surface 18 and is set into oscillation via the action of the spring 16. The mass 15A comes into repeated contact with the annular contact surface 18, allowing current to flow through the light emitting diode and the light emitting diode to be activated for light emission upon each contact.

The emitted light from the decorative body 5 provides an aesthetically pleasing effect, for example, similar to that of a swimming pool or fountain that is illuminated via underwater lighting. As a result, in the fluid dispensing device of the present embodiment, the light emitting diode is activated to emit light when the fluid dispensing device is in use and not during an idle state of the fluid dispensing device.

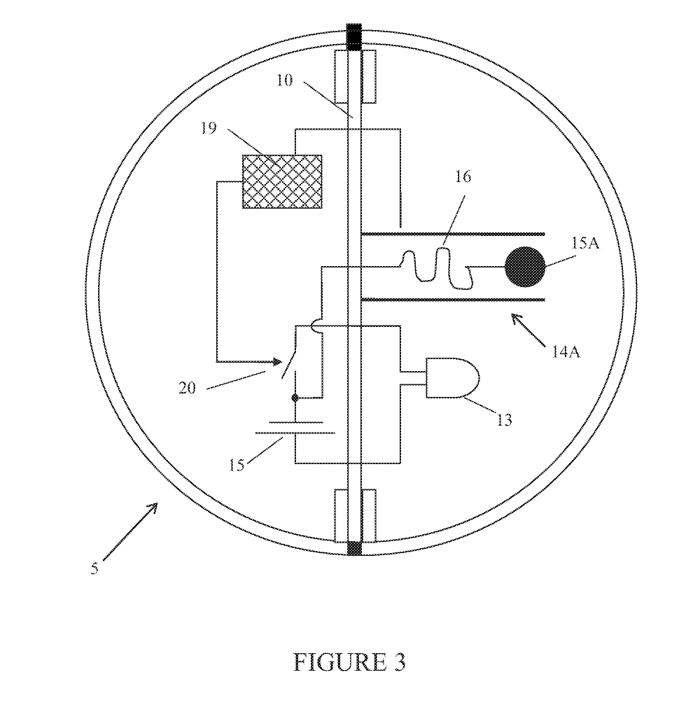

In a second exemplary embodiment of the present invention, as illustrated in FIG. 3, the activation means 14 further includes a switch 20 and a controller 19 for controlling activation of the light emission means 13 via the switch 20.

Although not illustrated, the battery 15 may also provide energy for the operation of the controller 19. In this second embodiment, the terminals of the battery 15 are connected to the terminals of the spring 16 and the light emitting means 13. The switch 20 is placed between one terminal of the battery 15 and one terminal of the light emitting means 13. The extremity of the spring 16 fixed to the support 10 is connected to one terminal of the battery 15. The controller 19 is also connected to the annular contact 17.

When mass 15A comes into contact with the annular contact 17, following movement of the fluid dispensing device 1, controller 19 is configured to detect a logic state level change that is produced upon contact, that is, a logic state level that changes from that of an open circuit of the spring 6 to one terminal of the battery 15 to that of a close circuit of the spring 6 to one terminal of the battery 15 when the mass 15A comes into contact with the annular contact 17. The controller 19 is configured to open and close the switch 20. The controller is configured to close the switch 20 when the above change in logic state level occurs and to open the switch 20 after a predetermined time duration, between 5 and seconds, for example, corresponding approximately to the time the fluid dispensing device is normally in use.

When the fluid dispensing device 1 or the decorative body 5 is moved, the mass 15A comes into contact with annular contact surface 18. The controller 19 detects this contact via a logic state level change and turns on switch 20 to allow current to flow to the light emitting diode and light emission for a predetermined time duration. The emitted light from the decorative body 5 provides the previously mentioned aesthetically pleasing effect.

As a result, in the fluid dispensing device of the present embodiment, the light emitting diode is activated to emit light when the fluid dispensing device is in use and not during an idle state of the fluid dispensing device 1 or, for example, during the transport in a handbag. The lifetime during which the aesthetically pleasing effect of the decorative body 5 is present for the user is significantly extended and returns to the fabricant of fluid dispensing devices that no longer function are significantly reduced.

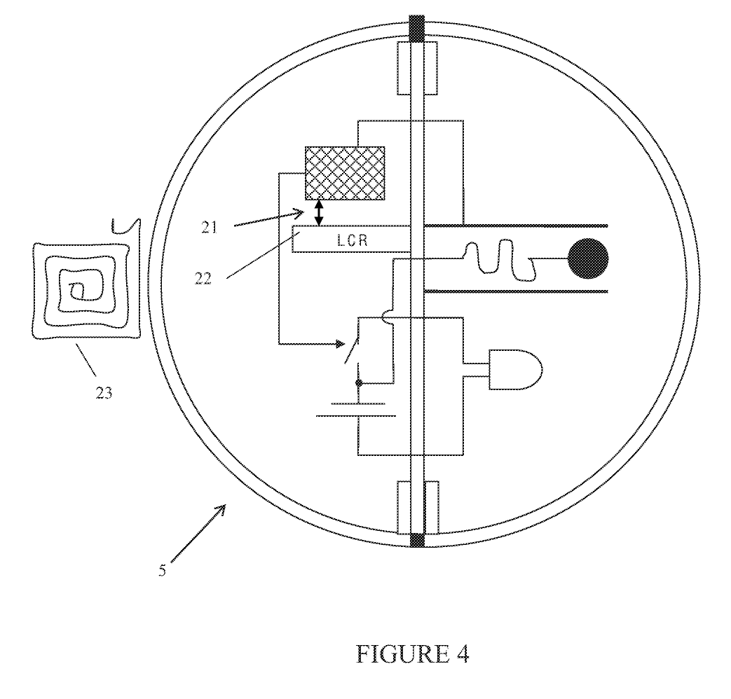

In a third exemplary embodiment of the present invention, as illustrated in FIG. 4, the fluid dispensing device of the second exemplary embodiment further includes energy saving means 21 for preventing operation of the activation means 14. The energy saving means 21 comprises a LCR circuit 22 that is configured and accorded to cooperate with a passive label 23. An LCR circuit is a type of circuit that includes a capacitor, an inductor, and a resistor (See, e.g., E. Coates, AC Theory Module 9 (2010)).

The passive label 23 is, for example, a plastic strip enclosing an iron ribbon or an RF tag (radio frequency tag) comprising an RC circuit (resistor-capacitor circuit) connected to an antenna of aluminium ribbon that is helicoidally wound and bonded to a piece of paper and accorded to a desired frequency response. The passive label 23 can be present on the cap 4A of the distribution pump 4 or on a packaging that holds the fluid dispensing device, preferably located in close proximity permitting the passive label 23 to be detected by the controller 19 via the LCR circuit 22. The LCR circuit 22, which may be an radio frequency identification (RFID) tag reader, is matched to detect the presence of the passive label 23 and to prevent the controller 19 closing the switch 20 to activate the light emitting means 13 when the presence of the passive label 23 is detected.

The controller 19 via the LCR circuit 22 is further configured to operate in a first and second mode of operation. The LCR circuit 22 is configured to determine whether the passive label 23 is detected or not when the fluid dispensing device 1 or the decorative body 5 is moved after a predetermined time duration of, for example, 5 seconds. This may be cyclically repeated, for example every 5 seconds. When the fluid dispensing device 1 or the decorative body 5 is moved and if the LCR circuit 22 determines that the passive label 23 is not detected, the controller 19 is configured to change operation to operate in a second mode of operation.

In the second mode of operation, the controller 19 via the LCR circuit 22 is configured to determine whether the passive label 23 is detected or not when the fluid dispensing device 1 or the decorative body 5 is moved after a predetermined time duration of, for example, 2 seconds. This may be cyclically repeated, for example, every 2 seconds. If during the second mode of operation the passive label 23 is found to be present, then the LCR circuit 22 is configured to change operation back to the first mode of operation. In this way, the energy saving means 21 prevents activation of the light emitting means 13 shortly after the fluid dispensing device is placed back into its packaging. In fact, the activation means first detects the presence of movement, and if there is movement, then detects the presence of the passive label 23.

When the fluid dispensing device is in its packaging, or the cap is mounted on the distribution pump 4, the LCR circuit 22 detects the presence of the passive label 23 and prevents the controller 19 closing the switch 20 to activate the light emitting diode 13. However, once removed from its packaging or when the cap is removed from the distribution pump 4 and the passive label 23 is not detected by the LCR circuit 22, the fluid dispensing device will operate as previously indicated in the second embodiment to activate the light emitting diode 13 when the fluid dispensing device is moved.

During transportation of the fluid dispensing device, the aesthetically pleasing effect produced through light emission of the light emitting means no longer occurs. Consequently, the lifetime during which the aesthetically pleasing effect is present for the perfume user is maximised and the returns to the fabricant of fluid dispensing devices that longer function are minimised

In the above embodiments of the present invention, the diameter of the decorative body 5 may be in the range of 10 mm to 25 mm. Furthermore, the present invention is not limited to a substantially spherical shape and any shape can be used for the decorative body 5 as long as the electronic circuit 6 can be placed inside the decorative body 5 and be protected from fluid 3. For example, the decorative body may also be fixed to an internal tube 3A provided to transport fluid out of container 2. Alternatively, the decorative body may comprise one or more optical fibres linked to distribution pump 4.

Alternatively, in the above embodiments of the present invention, the decorative body 5 is made in one single piece and comprises an orifice through which the electronic circuit can be inserted into the inner chamber of the decorative body 5. The interior of the decorative body 5 can then be filled with a plastic material. The plastic material completely surrounds the electronic circuit 6 and when it hardens, the electronic circuit 6 is fully isolated from the surrounding fluid 3 when the decorative body 5 is in container 2.

The light emitting means 13 may be a white light emitting diode, although any light emitting diode emitting at any visible wavelength can also be used. Other solid-state light sources, such as low current threshold lasers, can equally be used instead of a light emitting diode.

Alternatively, in the above embodiments of the present invention, other mechanical motion detectors may be used, such as a Micro-Electro-Mechanical Systems (MEMS) motion sensor or a passive infrared sensors (PIR) motion sensor.

Generally, then, the present invention relates to fluid dispensing device (1) that includes a container (2) suitable for holding fluid, such as a perfume, a decorative body (5) located inside the container (2) and destined to be located in the fluid, wherein the decorative body (5) includes light emitting means (13), and activation means (14) for activating the light emitting means (13). The fluid dispensing device further includes, according to some embodiments, a passive label (23) arranged externally to the container (2) and adapted to cooperate with an LCR circuit (22) to control activation of the light emitting means (13).

Having described now the preferred embodiments of this invention, it will be apparent to one of skill in the art that other embodiments incorporating its concept may be used. It is felt, therefore, that this invention should not be limited to the disclosed embodiments, but rather should be limited only by the scope of the appended claims.

1. A fluid dispensing device comprising:
(a) a container suitable for holding fluid, wherein the container is a sealed liquid-tight container;
(b) a decorative body located inside the container and positioned to be located in fluid held by the container, wherein;
the decorative body includes light emitting means, and activation means connected to activate the light emitting means,
wherein
the activation means includes a motion detector disposed to detect movement of the fluid dispensing device, and
wherein the decorative body further comprises energy saving means operable to prevent operation of the activation means, and
wherein the energy saving means includes an LCR circuit; and
(c) a passive label arranged externally to the container and adapted to cooperate with the LCR circuit to control activation of the light emitting means, wherein the
passive label is an iron ribbon or an RF tag and the LCR circuit is adapted to detect the presence of the passive label.

2. The fluid dispensing device according to claim 1, wherein the motion detector comprises a mass, a spring, and an annular contact surrounding the mass and spring.

3. The fluid dispensing device according to claim 1, wherein said activation means further comprises a controller operably connected to control activation of the light emitting means.

4. The fluid dispensing device according to claim 1, wherein the light emitting means comprises a white light emitting diode.

5. The fluid dispensing device according to claim 1, further comprising:
(d) a spray cap and a protective cap arranged to cover the spray cap in order to avoid unintentional activation of the fluid dispenser.

6. The fluid dispensing device according to claim 5, wherein the passive label is fixed to the protective cap and is adapted to cooperate with the LCR circuit.

7. The fluid dispensing device according to claim 1, wherein the decorative body is translucent.

8. The fluid dispensing device according to claim 1, wherein the fluid held by the container is perfume.

9. The fluid dispensing device according to claim 2, wherein said activation means further comprises a controller operably connected to control activation of the light emitting means.

10. The fluid dispensing device according to claim 2, wherein the light emitting means comprises a white light emitting diode.

11. The fluid dispensing device according to claim 3, wherein the light emitting means comprises a white light emitting diode.

12. The fluid dispensing device according to claim 9, wherein the light emitting means comprises a white light emitting diode.

13. The fluid dispensing device according to claim 2, further comprising:
(d) a spray cap and a protective cap arranged to cover the spray cap in order to avoid unintentional activation of the fluid dispenser.

14. The fluid dispensing device according to claim 3, further comprising:
(d) a spray cap and a protective cap arranged to cover the spray cap in order to avoid unintentional activation of the fluid dispenser.

15. The fluid dispensing device according to claim 4, further comprising:
(d) a spray cap and a protective cap arranged to cover the spray cap in order to avoid unintentional activation of the fluid dispenser.

16. The fluid dispensing device according to claim 9, further comprising:
(d) a spray cap and a protective cap arranged to cover the spray cap in order to avoid unintentional activation of the fluid dispenser.

17. The fluid dispensing device according to claim 10, further comprising:
(d) a spray cap and a protective cap arranged to cover the spray cap in order to avoid unintentional activation of the fluid dispenser.

18. The fluid dispensing device according to claim 11, further comprising:
(d) a spray cap and a protective cap arranged to cover the spray cap in order to avoid unintentional activation of the fluid dispenser.

19. The fluid dispensing device according to claim 12, further comprising:
(d) a spray cap and a protective cap arranged to cover the spray cap in order to avoid unintentional activation of the fluid dispenser.
